(19) United States
(12) Patent Application Publication
(10) Pub. No.: US 2026/0100575 A1
(43) Pub. Date: Apr. 9, 2026

(54) SYSTEMS AND METHODS FOR MINIMIZING ELECTRICAL ARCING DURING DISCONNECTION

(71) Applicant: Dell Products L.P., Round Rock, TX (US)

(72) Inventors: Wei-Cheng YU, New Taipei City (TW); Merle J. WOOD, III, Round Rock, TX (US); Chin-Jui LIU, Taoyuan City (TW); Chi-Che WU, Taipei (TW); Chia-Jung TSAI, New Taipei City (TW)

(73) Assignee: Dell Products L.P., Round Rock, TX (US)

(21) Appl. No.: 18/909,315

(22) Filed: Oct. 8, 2024

(51) Int. Cl. H02H 7/20

(52) U.S. Cl. CPC H02H 7/20

(57) ABSTRACT

A connection interface for a source device may include switching circuitry for causing the source device to deliver electrical energy to a sink device via an output of the source device when the source device and the sink device are electrically coupled via a connection, discharge circuitry for discharging an output voltage on the output when the connection is disconnected, and control circuitry for causing the switching circuitry to be activated and the discharge circuitry to be deactivated when the source device and the sink device are electrically coupled via the connection and causing the switching circuitry to be deactivated and the discharge circuitry to be activated when the connection is disconnected.

### TECHNICAL FIELD

The present disclosure relates in general to information handling systems, and more particularly to methods and systems for minimizing electrical arcing during disconnection, particularly those devices from which an information handling system draws or delivers power, such as via a Universal Serial Bus (USB) Type-C Power Delivery (PD) connection.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increasingly, information handling systems are utilizing USB Type-C PD to provide power to information handling systems via a device (e.g., a display monitor or docking station) coupled to the information handling system (e.g., in addition to or in lieu of traditional mechanisms for powering an information handling system, such as a battery or its own alternating current power source) or to deliver power from an information handling system to a device (e.g., from the information handling system to a connected device such as a display monitor, external hard drive, speaker, or other peripheral).

The USB PD 3.1 specification divides power into two ranges: a Standard Power Range (SPR), with a maximum charging power of 100 W and a maximum voltage of 20V, and an Extended Power Range (EPR) with three newly-added voltages of 28 V, 36 V, and 48 V, with a maximum output power of 240 W. With these increased voltages under EPR, disconnecting or unplugging a USB Type-C connector may cause pin-to-pin electrical arcing between a plug (e.g., source) and a receptacle (e.g., sink) of the connection. Such arcing may be a result of a voltage differential that develops between contacts at time of disconnection, as the source side may remain at high voltage while the sink side voltage may rapidly discharge due to its loading. Over time, such disconnection-induced arcing may lead to connector damage. Accordingly, systems and methods to minimize or eliminate such arcing may be desired.

### SUMMARY

In accordance with the teachings of the present disclosure, the disadvantages and problems associated with electrical arcing due to disconnection of a connection may be reduced or eliminated.

In accordance with embodiments of the present disclosure, a connection interface for a source device may include switching circuitry for causing the source device to deliver electrical energy to a sink device via an output of the source device when the source device and the sink device are electrically coupled via a connection, discharge circuitry for discharging an output voltage on the output when the connection is disconnected, and control circuitry for causing the switching circuitry to be activated and the discharge circuitry to be deactivated when the source device and the sink device are electrically coupled via the connection and causing the switching circuitry to be deactivated and the discharge circuitry to be activated when the connection is disconnected.

In accordance with these and other embodiments of the present disclosure, a method may include causing, with switching circuitry, a source device to deliver electrical energy to a sink device via an output of the source device when the source device and the sink device are electrically coupled via a connection. The method may also include discharging, with discharge circuitry, an output voltage on the output when the connection is disconnected. The method may additionally include causing, with control circuitry, the switching circuitry to be activated and the discharge circuitry to be deactivated when the source device and the sink device are electrically coupled via the connection. The method may further include causing, with the control circuitry, the switching circuitry to be deactivated and the discharge circuitry to be activated when the connection is disconnected.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system including a source device and a sink device electrically coupled with a connection, in accordance with embodiments of the present disclosure;

FIG. 2 illustrates a flow chart of an example method for minimizing electrical arcing during disconnection of a sink device from a source device, in accordance with embodiments of the present disclosure;

FIG. 3 illustrates selected components of a source-side connection interface including multi-channel resistive discharge circuitry for discharging a connector voltage of the source, in accordance with embodiments of the present disclosure;

FIG. 4 illustrates selected components of a source-side connection interface including transistor-based discharge circuitry for discharging a connector voltage of the source, in accordance with embodiments of the present disclosure; and

FIG. 5 illustrates selected components of a source-side connection interface including discharge circuitry internal to a control circuitry of the source-side connection interface for discharging a connector voltage of the source, in accordance with embodiments of the present disclosure.

### DETAILED DESCRIPTION

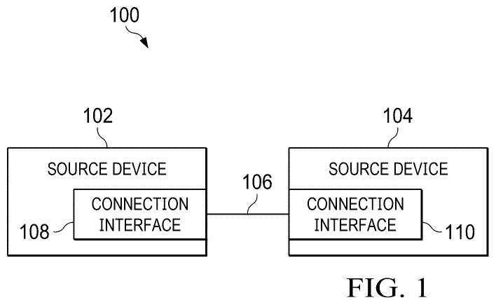

Preferred embodiments and their advantages are best understood by reference to FIGS. 1 through 5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 including a source device 102 and a sink device 104 electrically coupled to one another with a readily-removable connection 106, in accordance with embodiments of the present disclosure. Generally speaking, source device 102 may comprise any suitable system, device, or apparatus configured to provide electrical energy to sink device 104 via connection 106, and in turn, sink device 104 may comprise any suitable system, device, or apparatus configured to receive electrical energy via connection 106. Further, source device 102 and sink device 104 may communicate information to each other via connection 106, including without limitation control information concerning the provision of electrical energy from source device 102 to sink device 104 (e.g., negotiation of a power delivery profile defining a voltage, current, or power to be delivered via connector 106). Examples of source device 102 and sink device 104 may include, without limitation:
source device 102 is an alternating current adapter and sink device 104 is an information handling system or other electronic device (e.g., a mobile phone or tablet);
source device 102 is a battery charger and sink device 104 is a battery-operated device;
source device 102 is a docking station and sink device 104 is an information handling system;
source device 102 is an information handling system or other electronic device (e.g., a mobile phone or tablet) and sink device 104 is a peripheral device of source device 102 (e.g., a display monitor, external hard drive, speaker);
source device 102 is an information handling system or other electronic device and sink device 104 is another information handling system or other electronic device (e.g., source device 102 is an information handling system and sink device 104 is a mobile phone being charged from source device 102).

Connection 106 may be implemented using a cord, cable, or any other suitable electrical connection. For example, in some embodiments, source 102 may include a cord/cable with a plug configured to couple with a receptacle of sink device 104.

To enable such power delivery and communication, source device 102 and sink device 104 may include a connection interface 108 and connection interface 110 respectively. In some embodiments, each of connection interface 108 and connection interface 110 may comprise USB PD interfaces and connection 106 may comprise a USB PD connection. However, it is understood that the systems and methods described herein may be generally applicable to other connections between a source and a sink, and are not limited to USB PD connections and interfaces.

For purposes of clarity and exposition, source device 102 is depicted as only including connection interface 108 and sink device 104 is depicted as only including connection interface 110. However, it is understood that source device 102 and sink device 104 may include other components beyond those depicted in FIG. 1.

In operation, in response to a disconnection of connection 106 (e.g., removal of a plug associated with source device 102 from a receptacle of sink device 104), source device 102 may be configured to quickly discharge the source-side voltage at the output of connection interface 108 to minimize or eliminate electrical arcing between the outputs of connection interface 108 and connection interface 110, as described in greater detail below.

In some embodiments, connection interface 108 may include controllable discharge circuitry for discharging the source-side output voltage and a controller for controlling the controllable discharge circuitry to enable the controllable discharge circuitry to discharge the source-side output voltage in response to disconnection of connection 106. In some of these embodiments, a rate of discharge by the controllable discharge circuitry may be programmable. For example, upon a connection of connection 106, connection interface 108 and connection interface 110 may communicate configuration information to define a power delivery profile for the connection, and such configuration information may include a desired rate of discharge of the source-side voltage in the event of disconnection. For instance, in some embodiments, connection interface 110 may communicate configuration information defining the desired rate of discharge of the source-side voltage based on parameters of sink device 104 and/or user settings by a user of source device 102 and/or sink device 104.

In these and other embodiments, connection interface 108 may be an intelligent discharge management system, in that it may integrate a microcontroller that actively monitors the voltage levels following disconnection. Connection interface 108 may dynamically modify discharge path impedance, for example by using a combination of general purpose input/output (GPIO)-controlled resistors and/or switches to minimize arcing. Also, connection interface 108 may employ machine learning algorithms to predict optimal discharge timing based on usage patterns, potentially ensuring effective arc prevention without delaying the disconnection process. Further, connection interface 108 may incorporate an additional layer of protection with a fail-safe mechanism that instantly cuts off power if abnormal arcing is detected, safeguarding source device 102, sink device 104, and connectors of connection interfaces 108 and 110. In addition or alternatively, connection interface 108 and/or connection interface 110 may provide a user-friendly interface that allows for customization of discharge settings that may cater to various power profiles and/or user preferences.

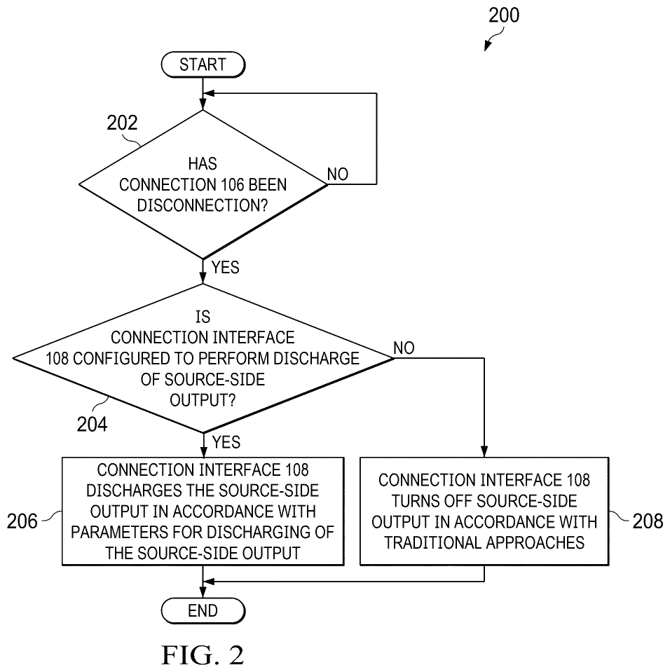

FIG. 2 illustrates a flow chart of an example method 200 for minimizing electrical arcing during disconnection of a sink device from a source device, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, connection interface 108 may determine if connection 106 has been disconnected. If connection 106 has been disconnected, method 200 may proceed to step 204. Otherwise, method 200 may remain at step 202 until connection 106 has been disconnected.

At step 204, in response to disconnection of connection 106, connection interface 108 may determine if it is configured to perform a discharge of the source-side output. For example, in some embodiments, connection interface 108 may be configured to perform a discharge of the source-side output if it has previously received configuration information from connection interface 110, a user, and/or elsewhere regarding parameters (e.g., a desired discharge rate) for discharging of the source-side output. If connection interface 108 is configured to perform a discharge of the source-side output, method 200 may proceed to step 206. Otherwise, method 200 may proceed to step 208.

At step 206, connection interface 108 may discharge the source-side output in accordance with parameters for discharging of the source-side output. After completion of step 206, method 200 may end.

At step 208, connection interface 108 may turn off the source-side output in accordance with traditional approaches. After completion of step 208, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using connection interface 108 and/or any other system operable to implement method 200. In certain embodiments, method 200 may be implemented partially or fully in software and/or firmware embodied in computer-readable media.

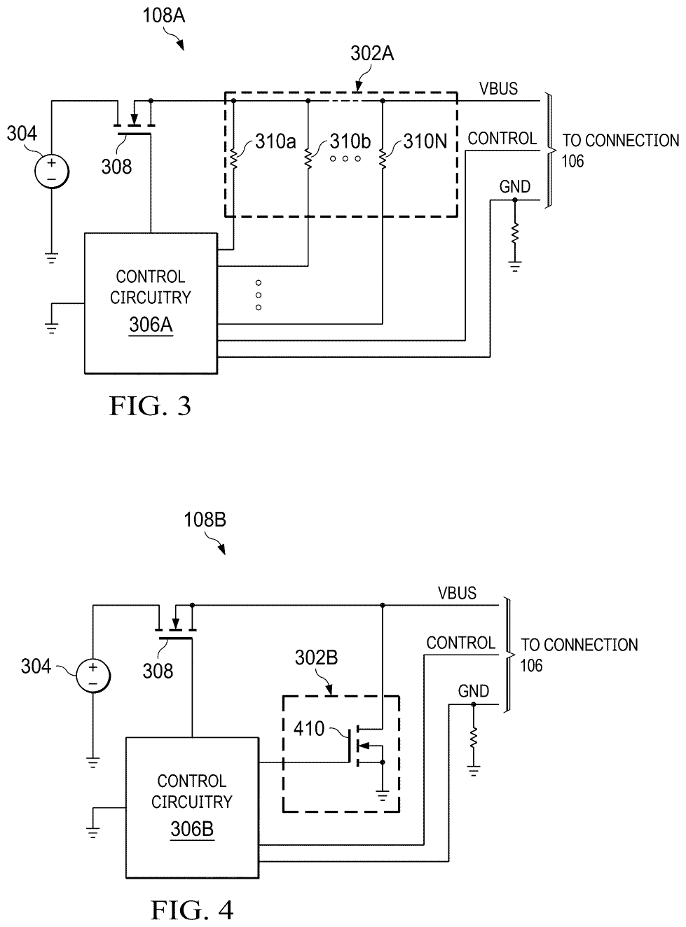

FIG. 3 illustrates selected components of a source-side connection interface 108A including multi-channel resistive discharge circuitry 302A for discharging an output voltage VBUS of source device 102, in accordance with embodiments of the present disclosure. In some embodiments, connection interface 108A may implement connection interface 108 depicted in FIG. 1 and described in connection with FIG. 2.

As shown in FIG. 3, connection interface 108A may include, in addition to discharge circuitry 302A, a voltage source 304, control circuitry 306A, and an enable switch 308.

Voltage source 304 may comprise any suitable system, device, or apparatus configured to generate a regulated direct-current input voltage. Accordingly, voltage source 304 may comprise an output of a voltage regulator, power converter (e.g., alternating-current-to-direct-current converter, direct-current-to-direct-current converter), or any other suitable system.

Control circuitry 306A may comprise any suitable system, device, or apparatus configured to control operation of connection interface 108A and its various components, including enable switch 308 and discharge circuitry 302A, as described in greater detail below.

Discharge circuitry 302A may comprise one or more discharge channels each having a resistor 310 (e.g., resistors 310a, 310b, . . . , 310N). In some embodiments, each discharge channel may comprise a general purpose input/output (GPIO) between control circuitry 306A and a respective resistor 310.

In operation, control circuitry 306A may, in response to a connected connection 106 between source device 102 and sink device 104, activate (e.g., enable, turn on, close) enable switch 308, thus bypassing the input voltage of voltage source 304 as output voltage VBUS to the output of connection interface 108A to provide electrical energy to sink device 104 via connection 106.

Further, in response to disconnection of connection 106 between source device 102 and sink device 104, control circuitry 306A may deactivate (e.g., disable, turn off, open) enable switch 308, and activate one or more channels of discharge circuitry 302A in order to discharge output voltage VBUS. In some embodiments, control circuity 306A may be able to control a rate of discharge (e.g., in accordance with a desired discharge rate communication via control signals CONTROL) by selectively controlling which of resistors 310a, 310b, . . . , 310N are activated, thus setting a resistance of discharge circuitry 302A to cause discharge in accordance with the desired discharge rate.

FIG. 4 illustrates selected components of a source-side connection interface 108B including transistor-based discharge circuitry 302B for discharging an output voltage VBUS of source device 102, in accordance with embodiments of the present disclosure. In some embodiments, connection interface 108B may implement connection interface 108 depicted in FIG. 1 and described in connection with FIG. 2. Connection interface 108B depicted in FIG. 4 may be similar in many respects to connection interface 108A of FIG. 3, and thus, only certain differences between connection interface 108A and connection interface 108B are described below.

In particular, connection interface 108B may include discharge circuitry 302B in lieu of discharge circuitry 302A and control circuitry 306B in lieu of control circuitry 306A. As shown in FIG. 4, discharge circuitry 302B may include a transistor 410 (e.g., a metal-oxide-semiconductor field-effect transistor) coupled at its gate to a control signal from control circuitry 306B and coupled at its non-gate terminals between output voltage VBUS and ground.

In operation, in response to disconnection of connection 106 between source device 102 and sink device 104, control circuitry 306B may deactivate enable switch 308, and activate transistor 410 in order to discharge output voltage VBUS. In some embodiments, control circuity 306B may be able to control a rate of discharge (e.g., in accordance with a desired discharge rate communication via control signals CONTROL) by driving transistor 410 in its linear region and controlling the effective resistance of the channel of transistor 410.

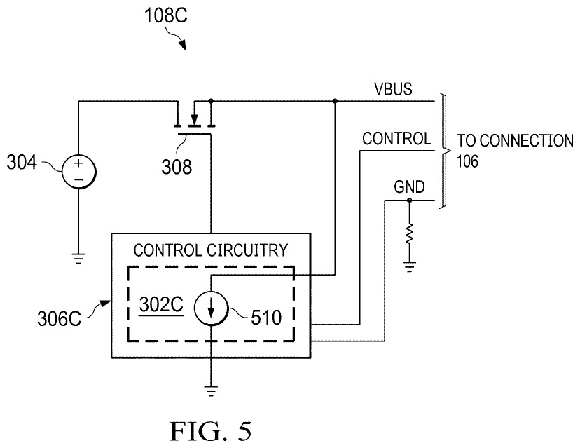

FIG. 5 illustrates selected components of a source-side connection interface 108C including discharge circuitry 302C internal to control circuitry 306c of the source-side connection interface for discharging a connector voltage of the source, in accordance with embodiments of the present disclosure. In some embodiments, connection interface 108C may implement connection interface 108 depicted in FIG. 1 and described in connection with FIG. 2. Connection interface 108C depicted in FIG. 5 may be similar in many respects to connection interface 108A of FIG. 3 and connection interface 108B of FIG. 4, and thus, only certain differences of connection interface 108C from connection interfaces 108A and 108B are described below.

In particular, connection interface 108C may include discharge circuitry 302C in lieu of discharge circuitry 302A and discharge circuitry 302B and control circuitry 306C in lieu of control circuitry 306A and control circuitry 306B. As shown in FIG. 5, discharge circuitry 302C may be integrated within control circuitry 306C, and may include a controllable current source 510.

In operation, in response to disconnection of connection 106 between source device 102 and sink device 104, control circuitry 306C may cause a constant current to flow through controllable current source 510 in order to discharge output voltage VBUS. In some embodiments, control circuity 306C may be able to control a rate of discharge (e.g., in accordance with a desired discharge rate communicated via control signal CONTROL) by controlling the magnitude of such current.

In some embodiments, control circuitry 306A, 306B, and/or 306C may include an integrated circuit. In some of such embodiments, control circuitry 306A, 306B, and/or 306C may include a USB PD controller IC.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A connection interface for a source device comprising:
switching circuitry for causing the source device to deliver electrical energy to a sink device via an output of the source device when the source device and the sink device are electrically coupled via a connection;
discharge circuitry for discharging an output voltage on the output when the connection is disconnected; and
control circuitry for:
causing the switching circuitry to be activated and the discharge circuitry to be deactivated when the source device and the sink device are electrically coupled via the connection; and
causing the switching circuitry to be deactivated and the discharge circuitry to be activated when the connection is disconnected.

2. The connection interface of claim 1, wherein the discharge circuitry and the control circuitry are configured to control a rate of discharge of the output voltage when the connection is disconnected.

3. The connection interface of claim 2, wherein the rate of discharge is set by configuration information received by the control circuitry from the sink device.

4. The connection interface of claim 1, wherein the discharge circuitry comprises one or more discharge channels, each of the one of more discharge channels having a resistor coupled to the output and wherein the control circuitry is configured to control the one or more discharge channels in order to control a resistance of the transistor to discharge the output voltage.

5. The connection interface of claim 1, wherein the discharge circuitry comprises a transistor coupled between the output and a ground voltage and wherein the control circuitry is configured to control a resistance of the transistor to discharge the output voltage.

6. The connection interface of claim 1, wherein the discharge circuitry comprises a current source integral to the control circuity and wherein the control circuitry is configured to control a current of the current source to discharge the output voltage.

7. The connection interface of claim 1, wherein:
the source device and the sink device are each Universal Serial Bus Power Delivery devices; and
the connection is a Universal Serial Bus Power Delivery connection.

8. A method comprising:
causing, with switching circuitry, a source device to deliver electrical energy to a sink device via an output of the source device when the source device and the sink device are electrically coupled via a connection;
discharging, with discharge circuitry, an output voltage on the output when the connection is disconnected;
causing, with control circuitry, the switching circuitry to be activated and the discharge circuitry to be deactivated when the source device and the sink device are electrically coupled via the connection; and
causing, with the control circuitry, the switching circuitry to be deactivated and the discharge circuitry to be activated when the connection is disconnected.

9. The method of claim 8, further comprising controlling, with the discharge circuitry and the control circuitry, a rate of discharge of the output voltage when the connection is disconnected.

10. The method of claim 9, wherein the rate of discharge is set by configuration information received by the control circuitry from the sink device.

11. The method of claim 8, wherein the discharge circuitry comprises one or more discharge channels, each of the one of more discharge channels having a resistor coupled to the output and the method further comprising controlling the one or more discharge channels in order to control a resistance of the transistor to discharge the output voltage.

12. The method of claim 8, wherein the discharge circuitry comprises a transistor coupled between the output and a ground voltage and wherein the method further comprising controlling a resistance of the transistor to discharge the output voltage.

13. The method of claim 8, wherein the discharge circuitry comprises a current source integral to the control circuity and the method further comprises controlling a current of the current source to discharge the output voltage.

14. The method of claim 8, wherein:
the source device and the sink device are each Universal Serial Bus Power Delivery devices; and
the connection is a Universal Serial Bus Power Delivery connection.
